(19) United States
(12) Patent Application Publication
(10) Pub. No.: US 2025/0031799 A1
(43) Pub. Date: Jan. 30, 2025

(54) Rolled Inner Seam Strap Design for Footwear to Reduce Strap-Induced Pressure on Dorsal Foot Aspect

(71) Applicant: Shreya Rao, Chapel Hill, NC (US)

(72) Inventor: Shreya Rao, Chapel Hill, NC (US)

(21) Appl. No.: 18/227,935

(22) Filed: Jul. 30, 2023

(51) Int. Cl. A43B 3/12; A43B 7/1455; B29D 35/12

(52) U.S. Cl. CPC A43B 3/126; A43B 7/147; B29D 35/128

(57) ABSTRACT

The invention presents a rolled inner seam strap (RIS) design for open-toe footwear, like flip-flops, to address foot ulcers caused by straps. Existing designs overlook the impact of strap-induced pressure on the dorsal foot, leaving a research gap. The RIS design aims to minimize pressure and friction on the dorsal foot, particularly at the toehold area where ulcers may occur. By increasing contact area with the skin and reducing strap contact, it redistributes pressure, preventing tissue damage. A study comparing RIS to traditional straps showed significantly lower dorsal foot pressure with RIS. The RIS design offers a practical and cost-effective solution to reduce strap-induced pressure and prevent foot ulcers, particularly in resource-limited settings with limited foot care.

### FIELD OF THE INVENTION

The present invention relates to the field of footwear design, particularly open-toe footwear, such as flip-flops. The invention specifically addresses the issue of strap-induced pressure on the dorsal foot aspect, aiming to reduce the risk of foot ulcers and related complications, especially in vulnerable populations like individuals with diabetes and leprosy. The design innovation involves a rolled inner seam strap (RIS) as a practical and cost-effective solution to minimize pressure and friction on the dorsal foot, thereby mitigating the risk of strap-related foot ulcers. The invention's significance lies in its potential to improve foot comfort and prevent strap-induced injuries, particularly in resource-limited settings where comprehensive foot care is often lacking.

### BACKGROUND OF THE INVENTION

Foot ulcers, especially those caused by straps in footwear, pose a significant concern for individuals with diabetes and leprosy. These dorsal foot ulcers can lead to discomfort, pain, and potentially serious complications, making footwear design crucial in their prevention and management.1 The problem arises due to the excessive pressure and friction exerted by straps, which can lead to tissue damage and breakdown in susceptible individuals.

While plantar foot pressure measurements have been extensively studied, research on the impact of strap-induced pressure on the dorsal foot aspect remains limited. Previous studies have primarily focused on plantar pressure distribution, neglecting the potential harm caused by straps on the dorsal foot regions.1 This research gap highlights the need to investigate the pressure characteristics specifically associated with strap design and their potential role in dorsal foot ulcer development.

Flip-flops, a popular type of open-toe footwear, are widely used due to their simplicity, convenience, and breathability, making them a preferred choice in warm climates and for casual wear. However, the design of flip-flops, particularly the straps, can contribute to increased pressure and friction on the dorsal foot, potentially leading to the development of ulcers.1 Strap-related foot ulcers have been reported in individuals with diabetes and leprosy, emphasizing the importance of examining the impact of strap design on the development of dorsal foot ulcers.5

To address this issue, the present invention proposes a rolled inner seam strap (RIS) design in flip-flops. The RIS design reduces pressure and friction on the dorsal foot by increasing the surface area in contact with the skin and minimizing the contact area between the strap and the skin. This design innovation aims to distribute pressure more evenly, reducing the risk of tissue damage and breakdown, and potentially preventing the development of strap-related foot ulcers.

In light of the limitations of current footwear designs and the potential risks they pose to individuals at risk of foot ulcers, especially in resource-limited settings, the present invention offers a practical and cost-effective solution. By implementing the RIS design in flip-flops, footwear manufacturers can potentially improve foot comfort and reduce the incidence of strap-related foot ulcers. This has significant clinical implications, particularly for vulnerable populations, and may lead to improved foot care and reduced complications related to strap-induced pressure on the dorsal foot aspect.

### OBJECTS OF THE INVENTION

The primary objects of the present invention are as follows:

Reducing Strap-Induced Pressure: The main object of this invention is to provide a novel footwear design that effectively reduces strap-induced pressure on the dorsal foot aspect. By implementing the rolled inner seam strap (RIS) design in flip-flops and similar open-toe footwear, the invention aims to minimize pressure and friction on the toehold area, which is particularly vulnerable to strap-related foot ulcers.

Preventing Foot Ulcers: Another important object of the invention is to prevent the development of foot ulcers caused by straps in footwear, especially in individuals with diabetes and leprosy. The RIS design seeks to distribute pressure more evenly across the dorsal foot, thereby reducing the risk of tissue damage and skin breakdown, and ultimately preventing the occurrence of strap-related foot ulcers.

Improving Foot Comfort: The invention aims to enhance foot comfort for individuals wearing open-toe footwear by providing a design that minimizes pressure and friction. By reducing discomfort and potential injuries caused by straps, the RIS design seeks to offer an improved wearing experience for users.

Enhancing Footwear Design Options: The invention introduces an innovative and practical design option for open-toe footwear, specifically flip-flops. By incorporating the rolled inner seam strap (RIS) design, footwear manufacturers can expand their product offerings with a design that addresses the issue of strap-induced pressure and its associated risks.

Cost-Effective Solution: One of the objectives of the invention is to provide a cost-effective solution to address the problem of strap-induced pressure in footwear. The RIS design utilizes standard materials commonly used in flip-flop manufacturing, making it feasible for widespread implementation without significant cost escalation.

Clinical Benefits for Vulnerable Populations: The invention aims to benefit individuals at risk of foot ulcers, particularly those with neuropathic conditions such as diabetes and leprosy. By reducing the risk of strap-related foot ulcers, the RIS design has significant clinical implications and may lead to improved foot care and reduced complications in vulnerable populations.

Resource-Limited Settings: The invention seeks to offer a practical solution, especially in resource-limited settings where access to comprehensive foot care is often lacking. By providing a design innovation that can prevent foot ulcers caused by strap-induced pressure, the RIS design may help address a significant health concern in regions with limited healthcare resources.

Overall, the objects of the present invention are focused on providing a footwear design that effectively reduces strap-induced pressure, prevents foot ulcers, improves foot comfort, and offers a practical and cost-effective solution, particularly for vulnerable populations and resource-limited settings. By achieving these objectives, the invention contributes to the advancement of footwear technology, emphasizing the importance of foot health and comfort for users.

### SUMMARY OF THE INVENTION

The present invention introduces a rolled inner seam strap (RIS) design for open-toe footwear, specifically flip-flops, to address the issue of strap-induced pressure on the dorsal foot aspect. The primary objective of the invention is to reduce the risk of foot ulcers caused by straps in footwear, particularly in individuals with diabetes and leprosy, by minimizing pressure and friction on the toehold area. The RIS design redistributes pressure by increasing the surface area in contact with the skin and minimizing contact area with the strap, thereby reducing the risk of tissue damage and breakdown. A study comparing the RIS design to traditional strap designs demonstrates a significant reduction in pressure on the dorsal foot, confirming the potential benefits of this innovative footwear design.

The key features of the invention include practicality, cost-effectiveness, and clinical implications for vulnerable populations, especially in resource-limited settings. By providing a solution that prevents foot ulcers resulting from strap-induced pressure, the RIS design enhances foot comfort and may improve overall foot care.

The rolled inner seam strap (RIS) design offers a novel approach to address the issue of strap-induced pressure in open-toe footwear. The invention's significance lies in its potential to reduce the risk of strap-related foot ulcers, enhance foot comfort, and provide a practical and cost-effective solution for users, particularly in vulnerable populations and resource-limited settings.

### DETAILED DESCRIPTION OF THE INVENTION

The rolled inner seam strap (RIS) design for open-toe footwear is a novel and practical innovation aimed at reducing strap-induced pressure on the dorsal foot aspect, particularly in flip-flops. The following sections provide a comprehensive and detailed description of the invention, including its design features, manufacturing process, and the numerous benefits it offers to users.

### Design Features:

The RIS design centers around the construction of the strap in flip-flops. Unlike traditional straight edge straps commonly found in open-toe footwear, the RIS design involves rolling the inner seam of the strap along its length. This rolling creates a gentle, curved surface on the inside of the strap, while the outside remains smooth and straight.

The rolled inner seam is specifically implemented in the toehold area of the flip-flop strap, as this region is most susceptible to strap-induced pressure and friction. By utilizing a rolled surface, the RIS design increases the surface area in contact with the skin, leading to more even pressure distribution. This design feature reduces the concentration of pressure on specific points, minimizing the risk of tissue damage and skin irritation.

We conducted a study on 5 healthy female volunteers with 10 feet (5 left and 5 right) per arm, aimed to evaluate the impact of the RIS design compared to traditional strap designs (Control) on pressure at the toehold area during a standardized 5-step walk trial on a hardwood floor.

The results of the study revealed a statistically significant difference in pressure at the toehold area between the RIS and Control flip-flops (p=0.0014). The mean difference of −40.90 grams (95% CI: −61.22 to −20.58) indicated that the RIS exerted significantly lower pressure compared to the Control flip-flops. Specifically, the RIS group exhibited a mean pressure of 29.30 grams, while the Control group had a mean pressure of 70.20 grams at the toehold area.

These findings demonstrate that the RIS design effectively reduces strap-induced pressure on the dorsal foot, particularly at the toehold area. The curved inner surface of the RIS strap redistributes pressure, minimizing the concentration of pressure points and mitigating the risk of tissue damage and skin breakdown. The statistically significant results provide strong evidence of the invention's effectiveness in improving foot comfort and reducing the risk of strap-related foot ulcers.

The implementation of the RIS design in open-toe footwear has significant clinical implications, particularly for individuals at risk of foot ulcers, such as those with diabetes and leprosy. The reduction in strap-induced pressure, as demonstrated by the study results, provides a practical and cost-effective solution to minimize the risk of strap-related foot ulcers, especially in resource-limited settings where comprehensive foot care is lacking.

The RIS design innovation is particularly valuable for populations where flip-flops are the preferred footwear and foot ulcers pose a major concern. By improving foot comfort and reducing the incidence of strap-induced pressure and friction, the RIS design can contribute to the prevention of foot ulcers and subsequent complications, ultimately enhancing foot health and well-being in vulnerable populations.

The RIS design is compatible with various flip-flop styles, sizes, and materials, making it versatile and adaptable for different user preferences and fashion trends.

### Manufacturing Process:

The manufacturing process for flip-flops with the RIS design is similar to that of traditional flip-flops, ensuring ease of production and integration into existing footwear manufacturing practices. The key modification lies in the construction of the strap.

### Building the Mold for the RIS Design:

To implement the RIS design during the footwear manufacturing process, a custom mold is required to shape the strap with the desired rolled inner seam. The mold-building process involves the following steps:

### Design and Prototyping:

The first step in building the mold is to create a detailed design and prototype of the RIS strap. Using computer-aided design (CAD) software, footwear designers develop a 3D model of the strap, with the specific dimensions and curvature required for the rolled inner seam.

### Material Selection:

The next step involves selecting the appropriate material for the mold. The material should be durable, heat-resistant, and capable of producing a smooth surface on the strap. Commonly used materials for mold-making include silicone, polyurethane, and epoxy.

### Mold Core Creation:

The mold core is the central part of the mold that defines the shape and structure of the rolled inner seam strap. It is typically made from a hard, heat-resistant material that can withstand the molding process. The mold core is created by carving or machining the material according to the CAD design, ensuring that it accurately represents the desired RIS shape.

### Mold Cavity Construction:

The mold cavity is the negative space around the mold core that shapes the outer surface of the strap. It is built around the mold core using the selected material, creating a perfect fit. The mold cavity is designed to accommodate the rolled surface of the RIS strap, ensuring a seamless and consistent shape.

### Mold Assembly:

Once the mold core and mold cavity are complete, they are assembled to create the final mold. The mold core sits within the mold cavity, defining the internal rolled surface of the strap. The assembly is carefully secured to ensure accurate and uniform molding.

### Testing and Refinement:

Before mass production, the mold is tested with prototype materials to ensure that the RIS design is accurately replicated. Any necessary adjustments or refinements are made to achieve the desired shape and functionality of the rolled inner seam strap.

### Benefits and Advantages of the Molded RIS Design:

Building the mold for the rolled inner seam strap offers several advantages:

Precision and Consistency: The mold ensures precise replication of the RIS design in each strap, maintaining consistency across multiple footwear units.

Efficient Production: Once the mold is built, the manufacturing process becomes more efficient, allowing for larger-scale production of RIS flip-flops.

Quality Assurance: The use of a custom mold guarantees the quality and accuracy of the rolled inner seam straps, reducing the likelihood of manufacturing defects.

Scalability: The mold allows for scalability in production, making it easier to meet consumer demand for RIS flip-flops.

Innovation and Differentiation: The molded RIS design sets the product apart from traditional flip-flops, providing an innovative and unique option in the footwear market.

The RIS design employs standard materials commonly used in flip-flop manufacturing, such as Rubber/PVC blends. This material choice ensures that the RIS flip-flops can be produced using existing production techniques and equipment without significant modifications or cost escalation.

### Benefits and Advantages:

The rolled inner seam strap (RIS) design offers numerous benefits and advantages:

### Pressure Reduction:

The primary advantage of the RIS design is its ability to significantly reduce strap-induced pressure on the dorsal foot aspect, especially at the toehold area. By redistributing pressure across a larger surface area, the RIS design minimizes the risk of localized pressure points that can lead to tissue damage, skin breakdown, and ultimately, foot ulcers.

### Enhanced Foot Comfort:

The RIS design substantially improves foot comfort for users. The rounded and smooth inner surface of the strap reduces friction and irritation commonly associated with traditional straight edge straps, providing a more pleasant wearing experience.

### Footwear Variety:

The RIS design introduces a new and innovative option for open-toe footwear, particularly flip-flops. Footwear manufacturers can now offer customers a choice that addresses the issue of strap-induced pressure and its associated risks, expanding the variety of available footwear designs.

### Clinical Implications:

The implementation of the RIS design has significant clinical implications, especially for individuals at risk of foot ulcers, such as those with diabetes and leprosy. By reducing the risk of strap-related foot ulcers, the RIS design may lead to improved foot care and reduced complications in vulnerable populations, promoting overall foot health.

### Cost-Effectiveness:

The RIS design utilizes standard materials and existing production techniques, making the manufacturing process cost-effective. This cost efficiency ensures that the RIS flip-flops remain accessible and practical, particularly in resource-limited settings where comprehensive foot care may be lacking.

### Applications:

The rolled inner seam strap (RIS) design is versatile and applicable to various open-toe footwear, including but not limited to flip-flops, sandals, and similar designs. The design can be adapted to fit various styles and sizes of footwear, catering to a wide range of user preferences and fashion trends.

The rolled inner seam strap (RIS) design for open-toe footwear presents a practical and effective solution to reduce strap-induced pressure on the dorsal foot aspect. By redistributing pressure and minimizing the risk of strap-related foot ulcers, the RIS design improves foot comfort and overall foot health for users. Its ease of integration into existing footwear manufacturing processes, along with the numerous benefits it offers, make the RIS design a valuable and innovative addition to the footwear industry. The design's potential applications span diverse open-toe footwear styles and sizes, and its implementation may particularly benefit individuals with diabetes, leprosy, and other vulnerable populations, as well as those in resource-limited settings.

### CITATIONS

[1] Ramaswamy, P., Rajan, P., Rima, J., & Richard, J. (2017). Footwear in the causation and prevention of foot ulcers in diabetes mellitus. The National Medical Journal of India, 30 (5), 255-259.
[2] Volmer-Thole M, Lobmann R. Neuropathy and Diabetic Foot Syndrome. Int J Mol Sci. 2016 Jun. 10; 17 (6): 917. doi: 10.3390/ijms17060917. PMID: 27294922; PMCID: PMC4926450.
[3] Razak A H, Zayegh A, Begg R K, Wahab Y. Foot plantar pressure measurement system: a review. Sensors (Basel). 2012; 12 (7): 9884-912. doi: 10.3390/s120709884. Epub 2012 Jul. 23. PMID: 23012576; PMCID: PMC3444133.
[4] https://www.universityofcalifornia.edu/news/guilt-free-flip-flop
[5] Kesav, P., Vy, V., & Prabhakar, S. (2013). Non-trophic cutaneous ulcers in lepromatous leprosy. The American Journal of Tropical Medicine and Hygiene, 89 (5), 1038-1039.

### Drawings

### DESCRIPTION

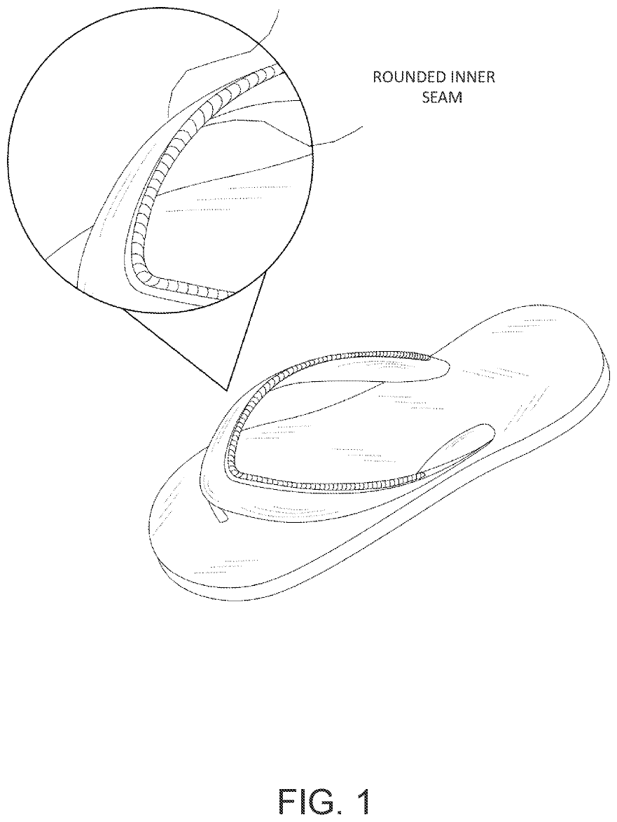

FIG. 1; is a magnified perspective view of the rolled inner seam strap of the present invention with a single flip flop.

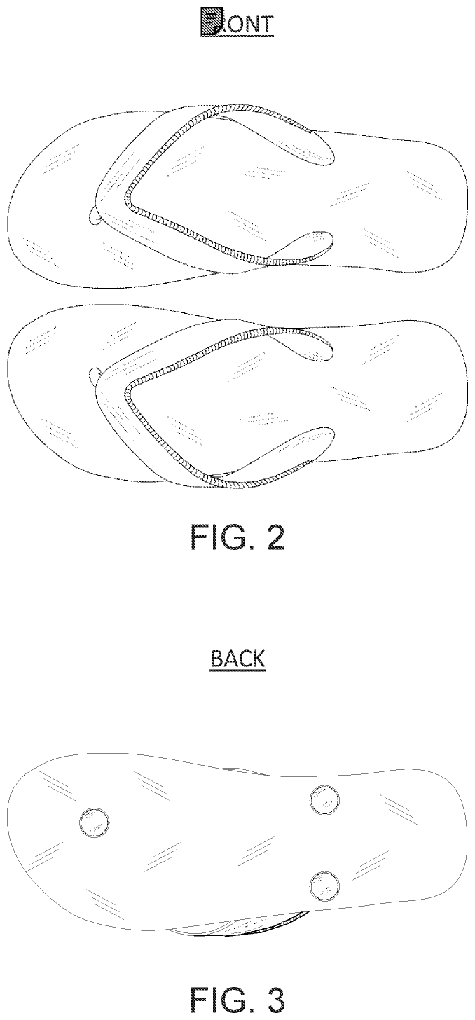

FIG. 2; is a top plan view of the rolled inner seam strap with the pair of flip flops present.

FIG. 3; is a bottom plan view of the rolled inner seam strap connected to the flip flop.

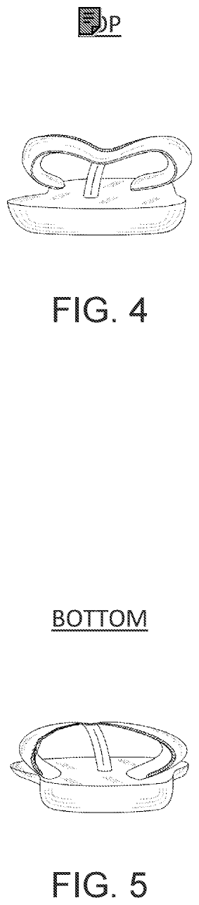

FIG. 4; is a frontal view of the rolled inner seam strap on the flip flop.

FIG. 5; is a rear view of the rolled inner seam strap with the flip flop.

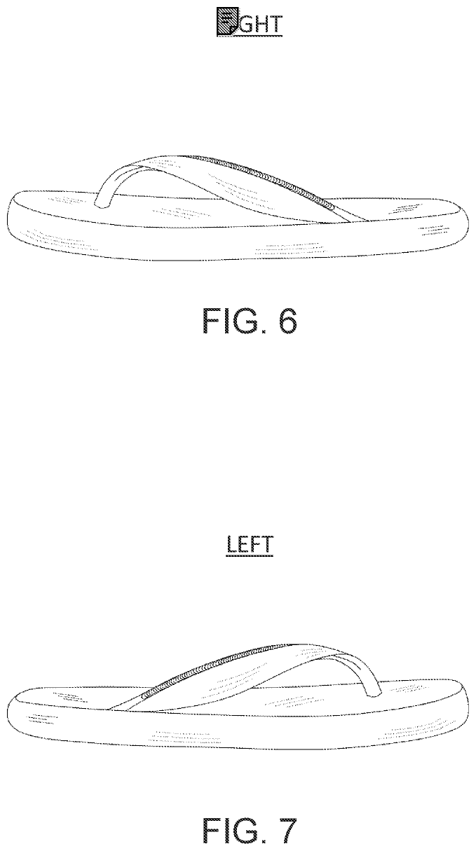

FIG. 6; is a left side view of the rolled inner seam strap with a single flip flop.

FIG. 7; is a right side view of the rolled inner seam strap with a single flip flop

### PROSPECTIVE

### Flip Flop Strap

The invention claimed is:

1. A footwear strap design comprising a rolled inner seam implemented along the length of the strap, wherein said rolled inner seam provides a curved surface on the inside of the strap and increases the surface area in contact with the dorsal foot aspect, thereby reducing strap-induced pressure and friction.

2. The footwear strap design of claim 1, wherein the rolled inner seam is targeted at the toehold area of the strap, thereby effectively mitigating the risk of tissue damage and skin breakdown in the toehold region.

3. A mold for manufacturing footwear straps, the mold comprising a mold core and a mold cavity, wherein the mold core defines a rolled inner surface, and the mold cavity shapes the outer surface of the strap, allowing the production of footwear straps with a rolled inner seam design as claimed in claim 1.

4. A method for manufacturing rolled inner seam straps for open-toe footwear, the method comprising: creating a custom mold as claimed in claim 3.

5. A pair of open-toe footwear comprising a sole and two straps, wherein the straps are equipped with the rolled inner seam design as claimed in claim 1, providing enhanced foot comfort and reducing strap-induced pressure on the dorsal foot aspect.

6. The pair of open-toe footwear of claim 5, wherein the open-toe footwear includes flip-flops, sandals, or similar designs, and the rolled inner seam design effectively reduces the risk of foot ulcers caused by strap-induced pressure.

7. A footwear design innovation for reducing strap-induced pressure on the dorsal foot aspect, the design comprising a rolled inner seam strap implemented in open-toe footwear, specifically flip-flops, as claimed in claim 1.

8. The footwear design innovation of claim 7, wherein the rolled inner seam strap is made from standard materials commonly used in flip-flop manufacturing, providing a cost-effective solution to reduce strap-induced pressure.

9. A footwear design aimed at preventing foot ulcers caused by straps, the design comprising the rolled inner seam strap as claimed in claim 1, and specifically targeted at individuals with diabetes and leprosy who are particularly vulnerable to foot ulcers.

10. The footwear design of claim 9, wherein the implementation of the rolled inner seam strap effectively reduces the risk of strap-related foot ulcers, offering significant clinical implications for foot health in vulnerable populations.
